(19) United States
(12) Patent Application Publication
(10) Pub. No.: US 2002/0022953 A1
(43) Pub. Date: Feb. 21, 2002

(54) Indexing and searching ideographic characters on the internet

(76) Inventors: Phillip Andre Bertolus, Victoria (AU); James Michael Jelbart, Victoria (AU); Timothy Grant Lewis, Victoria (AU)

Correspondence Address: Finnegan, Henderson, Farabow, Garrett & Dunner, L.L.P, 1300 I Street, N.W., Washington, DC, 20005-3315, US

(21) Appl. No.: 09/864,094

(22) Filed: May 24, 2001

Related U.S. Application Data
(63) Continuation-in-part of application No. 09/696,229, filed on Oct. 26, 2000.

(30) Foreign Application Priority Data
May 24, 2000 (AU) PQ 7730

(51) Int. Cl. G06F 17/20

(52) U.S. Cl. 704/1; 707/104.1

(57) ABSTRACT

A system allows the retrieval, indexing and searching of information stored on computers connected by a communications network, where that information comprises ideographic, logographic or pictographic characters, which are encoded using two bytes per character. The binary value, which encodes a particular character contained in a given document, is converted into hexadecimal text format, which is then prefixed with a predetermined marker character to indicate that it is the hexadecimal value of a double-byte character. That value is then added to a sequential string of such values for each of such characters in that document. The marker characters are then removed from this string, leaving a series of alphanumeric characters separated at set intervals by blank spaces. Each set of characters demarcated by a blank space is then indexed as if it were a standard word such as an English word, albeit a meaningless one. A unique index entry is created for each such word and phrase (up to a predetermined combination of such words) which the search engine encounters, and incorporates positional data which points to the location on the Internet of each occurrence of that particular word or phrase which the search engine has encountered. Search queries are then met by retrieving the positional data associated with each character or sequence of characters contained in the search query to determine whether any occurrence of those characters which has been encountered by the search engine meets the criteria of the user.

### RELATED APPLICATIONS

This application is a continuation-in-part of application Ser. No. 09/696,229, filed Oct. 26, 2000, which is hereby expressly incorporated in its entirety herein by reference, which in turn claims priority from Australian provisional application PQ7730, which is also hereby expressly incorporated in its entirety by reference.

### BACKGROUND OF THE INVENTION

A. Field of the Invention

The present invention relates generally to computer systems and methods for retrieving and indexing information on a network and, more particularly, to systems and methods used for retrieving and indexing information represented by ideographic characters on a networked system of computers, such as the Internet.

B. Description of the Related Art

Since its inception over 30 years ago in the United States, the Internet has remained predominantly Western in its content, with more than 80% of top-level Internet hosts and roughly 80% of Internet traffic using the English language. A survey of several hundred million web pages which was conducted in 1999 found that around 72% were in English, followed by Japanese with 7%, German with 5%, then French, Chinese and Spanish, each with between 1 and 2% (Geoffrey Nunberg, ‘Will the Internet always Speak English,’ The American Prospect vol. 11 no. 10, Mar. 27-Apr. 10, 2000). However, it is estimated that by 2003, non-English-speaking Internet users will exceed English-speaking users. In line with this projected growth, the amount of information on the Internet which is expressed using major Asian languages—such as Chinese, Japanese and Korean—is expanding rapidly.

There are, however, inherent obstacles against the use of Asian languages on the Internet and computers in general—particularly those Asian languages such as Chinese, Japanese and Korean, which use characters to represent information as opposed to the Roman script used by Western languages such as English.

The characters used in the Chinese, Japanese and Korean languages are described variously as ideographic, logographic, and pictographic, with each term having a slightly different linguistic connotation. For ease of reference, ‘ideographic’ will be used throughout this application as an umbrella term, which encompasses ideographic, logographic and pictographic characters.

The problem with using ideographic characters on computers lies in the way computer systems interpret, manipulate and display language which is comprehensible to users. Each discrete character used by a particular language is assigned a unique numerical character code, and it is that character code which the computer stores in binary form. To display the character in a form comprehensible to users, the computer then consults a table and finds the graphical representation (called a glyph) which corresponds with that particular character code, and it is that glyph which is displayed to the user, on a computer monitor for example.

This process of assigning a unique value to each character is easy with English, for example, as there are only 52 upper case and lower-case letters comprising the English alphabet. In the case of Chinese and Japanese, however, there are over 40,000 possible characters. The character set for Chinese is therefore several orders of magnitude greater than the English character set, and accordingly a larger range of values is required to provide a unique numerical representation for each character. At present, this representation is made mote difficult by the existence of a plurality of different systems for encoding those characters into numerical values.

Most English characters are encoded using a system called ASCII (American Standard Code for Information Interchange), which uses 7 binary digits (‘bits’) to represent each character. Each bit can take the value 1 or 0, so a 7-bit number can have 128 (2⁷) possible values. As there are only 52 upper and lower-case letters in the English language this is more than sufficient for encoding English text. For languages such as Chinese, however, 16 bits are required to provide an adequate code space to represent each character with a unique value. The use of 16 bits allows 65,536 (2¹⁶) possible values, and characters encoded in this way are often referred to as double-byte characters, because 8 bits equal one byte. Commonly used double-byte encoding systems for ideographic characters include GB 2312-80 (Chinese), Big 5 (Chinese), EUC (Japanese) and Shift-JIS (Japanese).

An additional problem with the languages that use ideographic characters is the difficulty of segmenting text comprised of ideographic characters into meaningful units such as words and phrases. In conducting a typical search, a user wants to find documents which contain particular words or phrases. In most languages, discrete words are made identifiable through the use of separator characters such as a comma, full stop or space between groupings of characters. In languages such as Japanese and Chinese, however, such separator characters are generally not used.

The grammatical structure of the Chinese language, in particular, relies heavily on context for determining the meaning of individual characters. Native speakers use their knowledge of word meaning and context to figure out where the word boundaries are. Any given Chinese character is a meaningful unit in itself, but when used in a particular context or in combination with other characters it can assume a totally different meaning. In a string of Chinese characters, it is therefore often difficult to tell whether a character is being used in conjunction with adjacent characters to form a longer ‘word’ or whether it is being used as a word or grammatical particle in itself. This acquired skill is very difficult for a computer to perform, so rather than attempt a semantic analysis of a given string of text, ‘workaround’ techniques are needed which approximate the same results but can be performed easily by a computer.

The traditional technique for indexing and searching information represented using ideographic characters is to create separate index entries for each possible meaningful unit. Given the string of three ideographic characters ‘abc,’ for example, ‘a’ in itself could be a word, as could be ‘b’, ‘c’, ‘ab’, ‘bc’ and ‘abc.’ Traditional indexing methods, such as that described in U.S. Pat. No. 6,021,409 entitled ‘Method for parsing, indexing and searching world-wide-web pages’ to Digital Equipment Corporation, would create separate index entries for each one of these possibilities, which it describes as ‘indexable words.’ If a user were then to search for the word ‘abc’, the search engine could then go directly to the index entry for ‘abc’ to determine where that term had occurred.

When confronted with double-byte character values, traditional search engines either index those characters in their double-byte form (often with special ‘escape sequences’ of characters to denote that the following indexed value is that of a double-byte character) or translate the character using a dictionary look-up, and index the English translation. These methods are cumbersome and either require that a separate index be created for double-byte characters, or place undue demands on storage space and computational resources, which are magnified as the index database grows larger. These demands then serve as an obstacle against the creation of extensive and up-to-date databases.

Based on the foregoing, there is a need for a system that efficiently collects and indexes stored information represented by ideographic characters on networks such as the Internet, and which is capable of integrating that information into existing indexes where it can be efficiently searched to produce meaningful and relevant results in a timely manner.

### SUMMARY OF THE INVENTION

In general, the present invention provides a method and system for retrieving, indexing and searching information, which is represented by ideographic, pictographic, or logographic characters, and which is stored on a network of computers, such as the Internet.

In one implementation consistent with the present invention a method is provided for indexing stored information, which partially or wholly consists of encoded ideographic, logographic, or pictographic characters. The method creates a first index entry for each individual character contained in the stored information using a search engine. The method adds to the first index entry for each individual character a first pointer, which indicates the location of each occurrence of that character, which the search engine has encountered. The method creates a second index entry for each sequential string of characters, up to a predetermined length, contained in the stored information using the search engine. The method adds to the second index entry for each sequential string of characters a second pointer, which indicates the location of each occurrence of that sequence which the search engine has encountered.

In another implementation consistent with the present invention another method for indexing stored information is provided. The method retrieves stored information comprising character information, which is encoded using two bytes to represent each character. The method converts the numerical values used to encode each character into hexadecimal format with a corresponding hex value and then adds a predetermined marker character to the beginning of each hex value to produce a marked character value. The method merges the marked character values into a single string of characters in the same sequential order in which they occurred in the stored information. The method then replaces each instance of the marker character with a blank space and adds each set of characters that is demarcated by a blank space to an index along with a pointer to the location at which that set of characters occurred.

In yet another implementation consistent with the present invention yet another method for searching stored information is provided. The method receives a search query from a user comprising a number of ideographic, logographic, or pictographic character encoded using two bytes to represent each character. The method converts the numerical values used to encode each character in the search query into hexadecimal format to produce a hex value and adds a predetermined marker character to the beginning of each hex value to produce a marked character value. The method merges the marked character values into a single string of characters in the same sequential order in which they occurred in the search query. The method replaces each instance of the market character with a blank space. The method searches the index for each occurrence of the single string of characters.

In yet another implementation consistent with the present invention yet another method for searching stored information is provided. The method receives a search query from a user comprising a number of ideographic, logographic, or pictographic character encoded using two bytes to represent each character. The method converts the numerical values used to encode each character in the search query into hexadecimal format to produce a hex value and adds a predetermined marker character to the beginning of each hex value to produce a marked character value. The method merges the marked character values into a single string of characters in the same sequential order in which they occurred in the search query. The method replaces each instance of the marker character with a blank space. The method searches the index for each occurrence of each individual character contained in the search query. The method examines the positional data describing the location of each occurrence of each individual character contained in the search query. The method determines whether the positional data indicates that any of the character occurrences contained in the index match the character comprising the search query.

In another implementation consistent with the present invention a method for searching stored information is provided. The method receives a search query from a user comprising more than one ideographic, logographic, or pictographic characters encoded using at least two bytes per character. The method converts the numerical values used to encode each character in the search query into hexadecimal format to produce a hex value and adds a predetermined marker character to the beginning of each hex value to produce a marked character value. The method merges the marked character values into a single string of characters in the same sequential order in which they occurred in the search query. The method replaces each instance of the marker character with a blank space. The method searches the index for each occurrence of the sequence of characters which comprise the sequence of characters contained in the search query.

In another implementation consistent with the present invention, a system for indexing stored information that partially or wholly consists of encoded ideographic, logographic, or pictographic characters is provided. The system comprises means for, including a search engine, creating an index entry for each individual character contained in the stored information. The system further comprises means for adding to the first index entry for each individual character a first pointer which indicates the location of each occurrence of that character which the search engine has encountered. The system further comprises means for, including a search engine, creating a second index entry for each individual sequence of characters, up to a predetermined length, contained in the stored information using a search engine. The system further comprises means for adding to the second index entry for each individual sequence of characters a second pointer which indicates the location of each occurrence of that sequence which the search engine has encountered.

In yet another implementation consistent with the present invention, a system for indexing stored information is provided. The system comprises a spider for retrieving a document containing a string of characters and for converting the numerical values used to encode each character contained in the document into hexadecimal text format to produce a hex value, and for adding a predetermined marker character to the beginning of each hex value to produce a marked character value, wherein the spider is also used for merging the marked character values in to a single string. The system further comprises a storage device for storing the single string. The system further comprises an indexer for replacing each instance of the marker character with a blank space and for adding each word separated by the blank space to an index database, and for adding positional data specifying the location of each word in the document.

### BRIEF DESCRIPTION OF THE DRAWINGS

The accompanying drawings, which ate incorporated in and constitute a part of this specification, illustrate an implementation of the invention and, together with the description, serve to explain the advantages and principles of the invention. In the drawings:

FIG. 1 is an illustration of a computer network for practicing methods and systems consistent with the present invention;

FIG. 2 is a diagram illustrating the conversion of the double-byte value of each ideographic character into the form in which it is indexed consistent with the present invention;

FIG. 3 is a diagram depicting a process for retrieving character information from the Internet, storing it in an index, and then searching in response to user queries consistent with the present invention;

FIG. 4 is a diagram illustrating a method for generating word lists for languages that use ideographic characters according to the present invention;

FIG. 5 is a diagram illustrating a further example of a method for generating word lists and indexing ideographic character information consistent with the present invention; and

FIG. 6 illustrates one embodiment of a process for handling a search query consistent with the present invention.

### DETAILED DESCRIPTION

The following detailed description of the invention refers to the accompanying drawings. Although the description includes exemplary implementations, other implementations are possible, and changes may be made to the implementations described without departing from the spirit and scope of the invention. Wherever possible, the same reference numbers will be used throughout the drawings and the following description to refer to the same or like parts.

As described in more detail below, the present invention employs a method of conversion of the numerical values used to encode ideographic characters into a format which allows the value for each character to be indexed such as, for example, if it were a normal word comprising simple ASCII (American Standard Code for Information Interchange) characters.

As further detailed below, in one form of the present invention, the system may index each individual character, rather than indexing each combination of the individual ideographic characters which could form meaningful units in a given string of characters. In response to a search query, the present invention may then use the positional data stored for each individual character comprising that search query to determine whether the required combination of those characters occurs in the documents that have been indexed. Because significantly fewer index entries are required, the storage requirements of the search engine are therefore reduced. Additionally, the demands on the computational resources of the search engine are lowered, because there are fewer index entries for it to search. Despite having fewer index entries, however, the present invention still allows the search engine to cover the full range of combinations of characters through use of the positional data for each individual character.

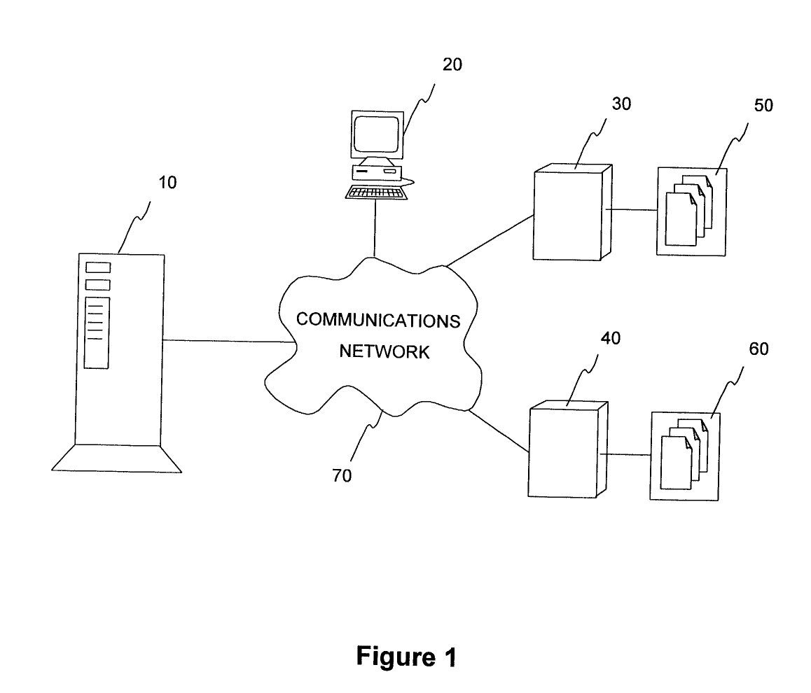

One embodiment of the present invention is a method for processing information which is retrieved from computers connected to a communications network. An arrangement of a computer network for practicing methods and systems consistent with the present invention is shown in FIG. 1.

The computer network includes a central computer 10, a remote computer 20, and a plurality of pages of information 50 and 60 distributively stored on one or more computer systems 30 and 40 which are to be searched. All of the computers in FIG. 1 are connected, either directly or indirectly, via a communications network 70. One skilled in the art will appreciate that even though FIG. 1 for sake of convenience depicts only two computer systems 30 and 40 with stored information as part of the computer network, millions of computers may be part of the computer network.

In one embodiment, the communications network 70 is the Internet, a Transmission Control Protocol/Internet Protocol (‘TCP/IP’) based network, and the computers are connected to communication network 70 using technology in common use. In other embodiments of the present invention, communications network 70 is any device or a combination of devices that allows computers 10, 30, 40 to communicate with each other. For example, communications network 70 can be a local area network, an Intranet, dedicated point-to-point communication lines, or a wireless transmission network. Furthermore, communications network 70 might take a different form for different pairs of computers. For example, central computer 10 might communicate to a computer system 30 via the Internet, and computer system 30 might communicate to remote computer 20 via a local area network.

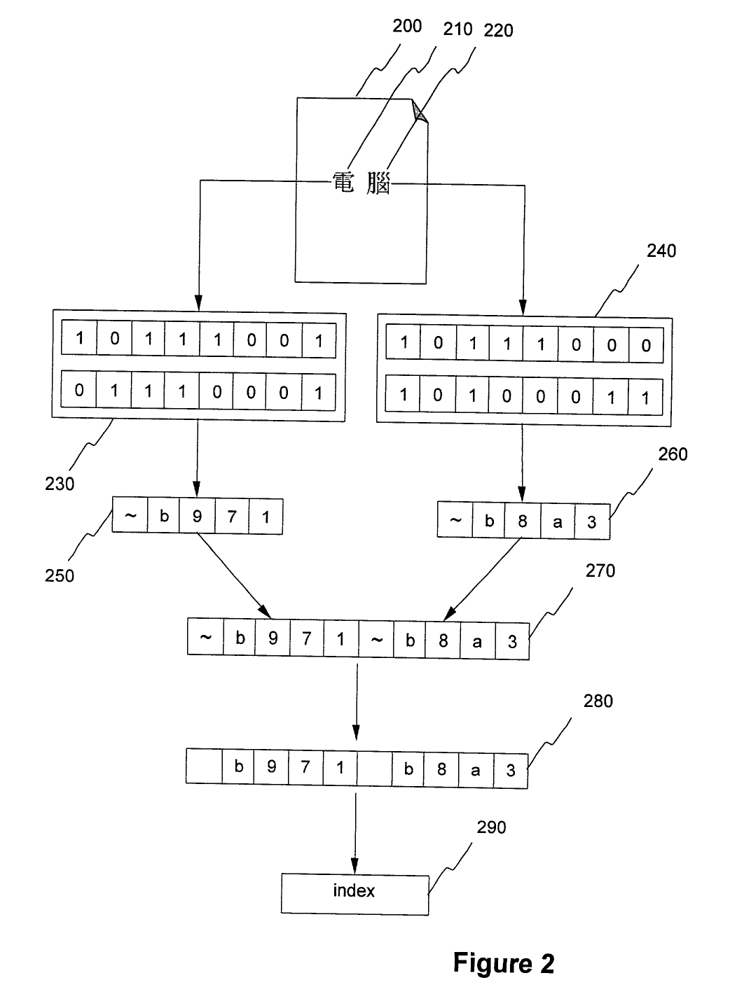

FIG. 2 illustrates the conversion of a numerical value used to encode a character, into a format which allows it to be indexed such as, for example, if it were a normal ‘word’ comprising simple ASCII characters.

Document 200 contains Chinese characters 210 and 220. In this example characters 210 and 220 are represented using traditional Chinese script and are encoded in the encoding standard known as ‘Big 5’, which encodes each Chinese character as a double-byte binary representation. The binary double-byte representations of Chinese characters 210 and 220 are 230 and 240 respectively. Each of double-byte values 230 and 240 may then be converted into hexadecimal format consisting of four ASCII characters. The hexadecimal values for characters 210 and 220 are each then prefaced by a marker character, in this case a tilde (˜), to produce marked values 250 and 260. The marker character preceding each converted value indicates to the indexing program that the following four ASCII characters represent one ideographic character expressed in hexadecimal format. One skilled in the art will appreciate that the double-byte values may be converted into another number system format to produce a string of alphanumeric characters, which may then be processed in a similar fashion as the ideographic character expressed in hexadecimal format. One skilled in the art will also appreciate that even though a tilde is used as the marker character, other symbols or means may be used as the market character.

The marked values 250 and 260 are then combined to form a single string 270 of ASCII characters. The market characters are then removed from string 270 to produce string 280, in which the groups of ASCII characters ‘b971’ and ‘b8a3’ are separated by blank spaces. String 280 can now be treated as if it were a string consisting of two normal English ‘words,’ albeit meaningless ones, with each word demarcated by a blank space. At this stage, string 280 is designated as being in so-called ‘Gobbledegook’ (GBY) format. GBY format allows values that represent ideographic characters to be indexed and searched as if they were conventional words, such as English words, segmented by spaces.

The GBY string 280 may then be indexed in a conventional manner, with each discrete ‘word’ and each sequence or ‘phrase’ of words, up to a predetermined length, having its own entry in index 290. In the example of FIG. 2, each time the search engine encounters another occurrence of character 210, it will add a pointer to the location of that occurrence to the index entry for the GBY format ‘word’ which corresponds to character 210. Similarly, each time the search engine encounters another occurrence of character combination 210 and 220, it will add a pointer to the location of that occurrence to the index entry for the GBY format ‘word’ combination which corresponds to characters 210 and 220.

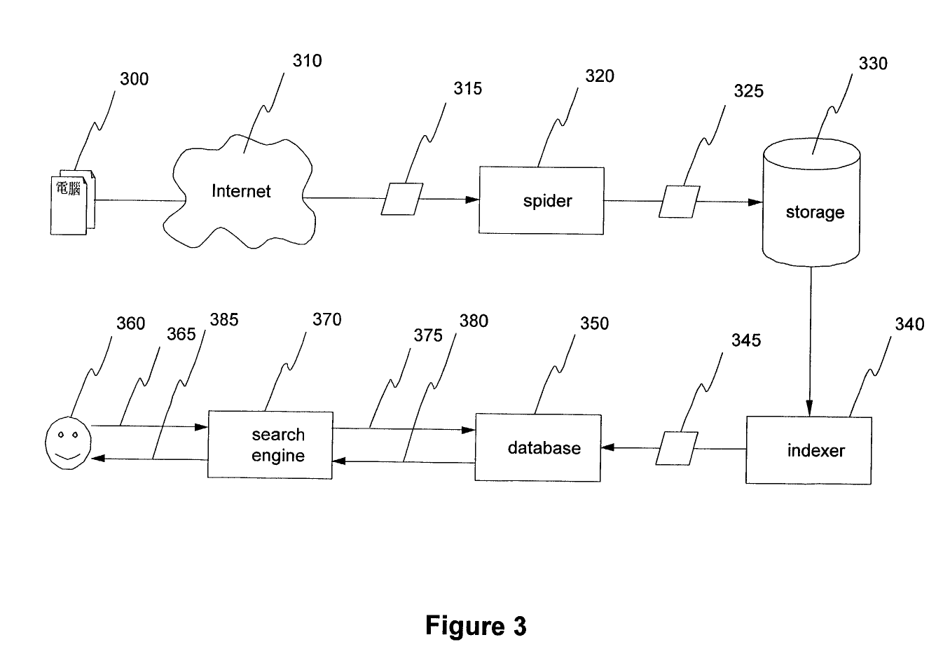

FIG. 3 represents diagrammatically a process by which information represented using ideographic characters is retrieved from the Internet, stored in an index, then searched in response to user queries.

Spider 320 retrieves a page of information 300 from a location on Internet 310 specified by a particular URL (Universal Resource Locator). In this example page 300 contains Chinese text encoded using a double-byte encoding system, such as GB 2312-80 or Big 5. Data 315 retrieved by spider 320 is converted by the spider 320 into hexadecimal format and the hexadecimal values for each character are prefaced by a tilde and then merged into a single string of ASCII characters 325. String 325 is then stored in storage 330 before being sent to indexer 340.

Indexer 340 removes all the tildes from string 325, to produce string 345. Each GBY format ‘word’ is then added to the index database 350, along with the positional data specifying where that ‘word’ (with its underlying character) occurred. Each sequential string of GBY format ‘words’, up to a predetermined string length, may also be added to the index database 350, along with the positional data specifying where that string or ‘phrase’ occurred.

The index database 350 is then accessed by search engine 370 in response to search queries 365 from the user 360. Search engine 370 retrieves and then ranks each occurrence 380 of the term(s) comprising the search query 365, and then sends the search results 385 to user 360.

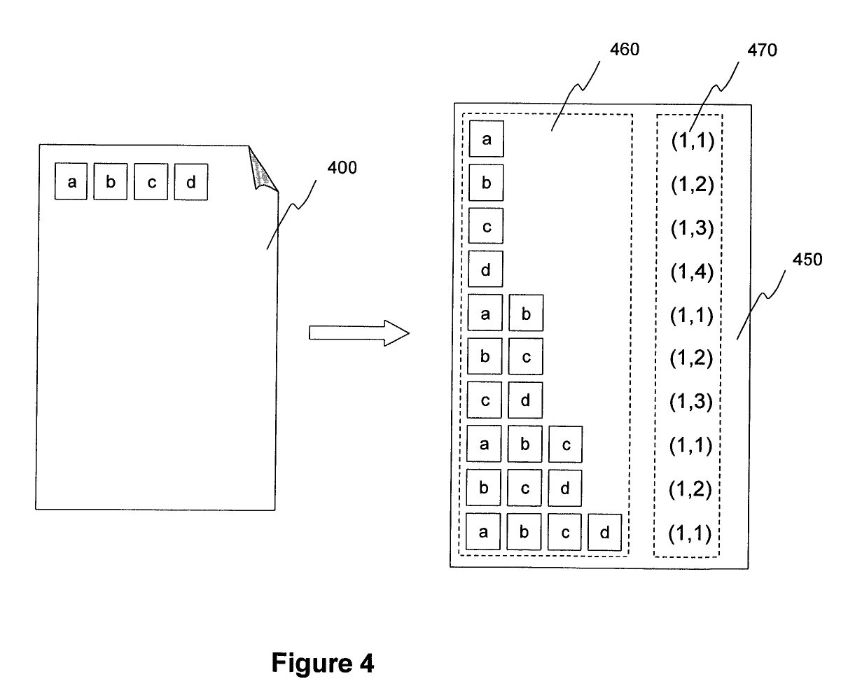

In FIG. 4, the method by which index entries are generated from strings of ideographic characters is illustrated in further detail. Ideographic characters may be indexed by creating a separate index entry not only for each individual character, but also for each possible combination of characters in a given string, up to a predetermined maximum string length. For example, document 400 contains a string of four characters ‘a’, ‘b’, ‘c’ and ‘d.’ From that string of four characters, this indexing method would produce index entries 450 comprising word list 460 which contains the ten discrete combinations: ‘a’, ‘b’, ‘c’, ‘d’, ‘ab’, ‘bc’, ‘cd’, ‘abc’, ‘bcd’, and ‘abcd’; and positional data 470 which points to each occurrence of each of the entries in word list 460. Because of the semantic structure of languages which use ideographic characters, it is possible that each of the ten combinations of characters identified in this example represent discrete meaningful units, so each combination is indexed as a separate entry. For example, if the string ‘abcd’ was a sentence of four Chinese characters, it is possible that ‘a’ could be the subject, ‘b’ could be the verb, and ‘cd’ could be the object. Alternatively, ‘a’ could be the verb, ‘bc’ could be the name of a town, and ‘d’ could be a grammatical particle signifying that the action indicated by the verb has been completed, or converting the phrase into interrogative form. It is therefore difficult to segment strings of ideographic characters to determine which components of that string constitute meaningful units in any given context. This indexing method addresses this difficulty by indexing all possible combinations of characters which could constitute meaningful units in a given string, creating an exhaustive word list as part of the index.

If a user then searches for the word ‘bcd,’ for example, the search engine would simply go directly to the entry for ‘bcd’ in its word list, look at the positional data which points to instances where the search engine has come across ‘bcd’, rank those results, and return the search result to the user.

In one form of the system, a dictionary of known meaningful terms may be used to filter out meaningless terms and phrases from this exhaustive word list, thus helping to reduce the list size and therefore also reducing search times. This filtering may be done by way of a statistical process, deleting those terms and phrases which do not appear to correlate with combinations of characters otherwise encountered by the indexer.

This method allows for relatively fast searches, yet for any given string of characters the number of possible combinations of those characters is relatively large, and indexing each combination in addition to indexing the individual characters can place heavy demands on storage space and computational resources.

The aggregation of the (ostensibly meaningless) GBY words into (ostensibly meaningless) phrases, as described above, can also be applied to English and other western language words and terms, along with the optional filtering steps if desired, as the phrase aggregation is not dependent on the underlying double-byte engine.

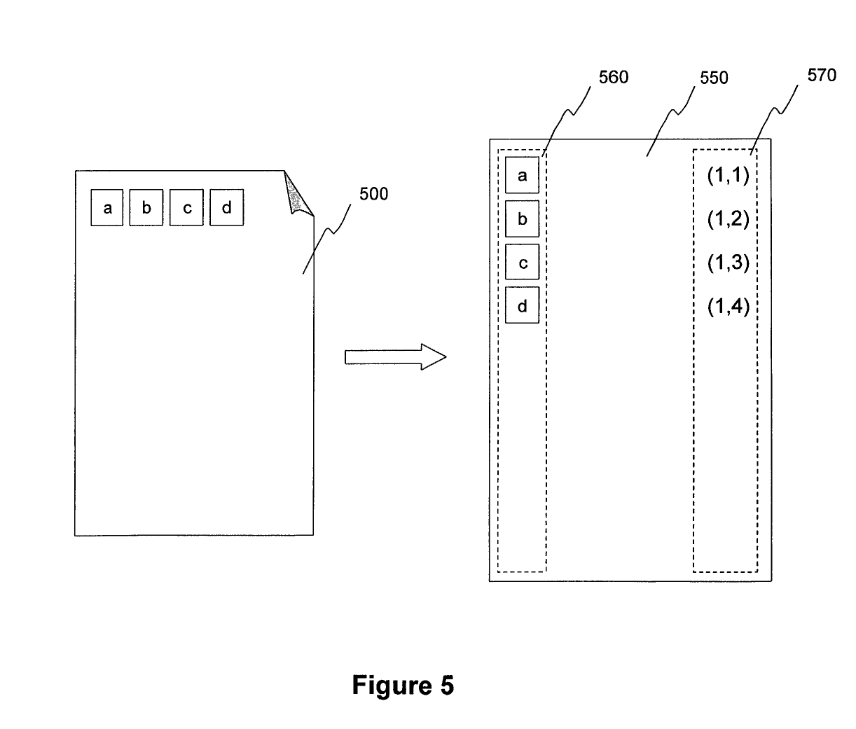

FIG. 5 illustrates one form of the manner in which the method of the present invention may generate index entries from information represented using ideographic characters.

Instead of indexing each possible combination of the characters contained in a given string, the system may simply index the individual characters, along with the positional data for each character. For example, document 500 contains a string of four characters ‘a’, ‘b’, ‘c’ and ‘d.’ From that string of four characters, the present invention would produce index entries 550 comprising a word list 560 of the four characters ‘a’, ‘b’, ‘c’, ‘d’, and positional data 570 which points to each occurrence of each of the entries in the word list 560.

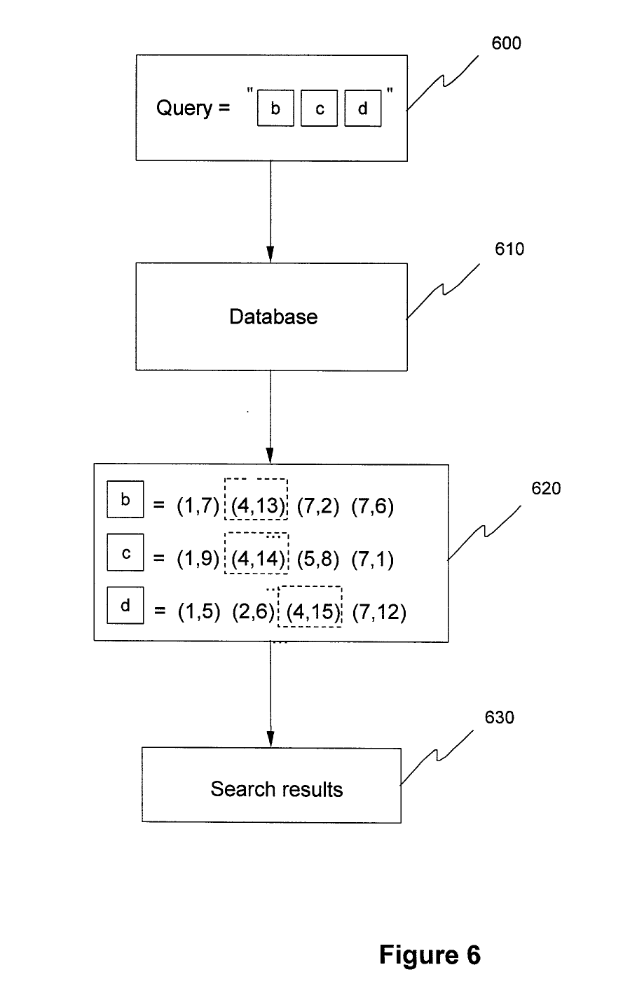

If a user were then to search for the character ‘c’, it would be a trivial matter of scanning the index for character ‘c’ and, in this case, returning a hit for document 1. The closer to the beginning of the page that ‘c’ appears, the higher the ranking that page will receive. If a user were to search for a word comprised of more than one character, such as ‘bcd,’ then the search engine would scan the index for each of the characters ‘b’, ‘c’ and ‘d,’ and then examine the positional data associated with each character to determine whether they occurred in proximity to one another. This process is set out in more detail in FIG. 6, which illustrates the manner in which a search query is processed in this particular form of the present invention.

A user enters search query 600 comprising one or more ideographic characters. In the example shown in FIG. 6, search query 600 consists of the word or phrase ‘bcd,’ where ‘b’, ‘c’ and ‘d’ are ideographic characters. The invention searches the index 610 for each of the individual characters which comprise search query 600 and retrieves the positional data 620 which points to each occurrence of those characters which the search engine has indexed. A an example of this approach, the positional data 620 may take the form: (document ID, word position). For example, (1,3) would indicate the third word on document number 1. Many alternative methods for recording positional data may of course be used.

Having retrieved the positional data 620 for each character in search query 600, the system then looks to see if there are any instances where the three characters comprising search query 600 are adjacent to each other on the same document. In the example, documents 1, 4 and 7 each contain all of the characters ‘b’, ‘c’ and ‘d’ which comprise search query 600. In document 4, however, the characters are adjacent to one another (in positions 13, 14 and 15) and are in the same order as specified in search query 600—this constitutes a perfect match for search query 600 and in this case will be returned to the user as the highest ranking search result 630.

If there is more than one result where the characters comprising search query 600 are adjacent to one another, the highest ranking will be assigned to those results in which ‘b’, ‘c’ and ‘d’ are closest to the beginning of the page. For example, if characters ‘b’, ‘c’ and ‘d’ also occurred in positions (10,1) (10,2) and (10,3) respectively, then that result would rank higher than (4,13) (4,14) and (4,15), as it occurs closer to the beginning of the page.

If there are several search results 630 where the characters comprising search query 600 are in the same position on the page, for example (10,1) (10,2) (10,3) and (11,1) (11,2) (11,3), then the number of additional occurrences of those characters on the page is also taken into account to differentiate between the results for ranking purposes. For example, if ‘bcd’ subsequently occurred six times on page 10, but only once on page 11, then page 10 would be ranked higher than page 11, notwithstanding that ‘bcd’ is the first term to occur on both pages. The greater the number of occurrences of the characters comprising search query 600 on a page, the more likely it is that that page will be of relevance to the user. One skilled in the art will appreciate that other strategies, such as statistical techniques, may be used to determine relevance to the user, and therefore the ranking of returned results.

The foregoing description of an implementation of the invention has been presented for purposes of illustration and description only. It is not exhaustive and does not limit the invention to the precise form disclosed. Modifications and variations are possible in light of the above teachings or may be acquired from practicing of the invention. For example, one embodiment described includes a method for indexing and searching Chinese characters. However, other embodiment may include other languages which use ideographic, pictographic or logographic characters to represent information, such as Japanese, Korean and Vietnamese. The examples disclosed above refer to the indexing and searching of ideographic characters encoded using the Big 5 double-byte encoding system for traditional Chinese characters. Ideographic characters may of course be encoded by means of alternative encoding systems, such as ‘GB 2312-80’, ‘Unicode’ and ‘HZ’.

1. A method for indexing stored information that partially or wholly consists of encoded ideographic, logographic or pictographic characters, comprising:
creating a first index entry for each individual character contained in the stored information using a search engine;
adding to the first index entry for each individual character a first pointer which indicates the location of each occurrence of that character which the search engine has encountered;
creating a second index entry for each sequential string of characters, up to a predetermined length, contained in the stored information using a search engine; and
adding to the second index entry for each sequential string of characters a second pointer which indicates the location of each occurrence of that sequence which the search engine has encountered.

2. The method of claim 1, wherein the stored information is a plurality of pages on the Internet.

3. The method of claim 1, wherein the characters are characters used to represent the Chinese language.

4. The method of claim 1, wherein the characters are encoded using two bytes per character.

5. The method of claim 1, wherein the stored information is stored in at least one storage device.

6. The method of claim 1, wherein the index entry comprises a unique word and positional data indicating the location of each occurrence of that word.

7. The method of claim 6, wherein the word comprises an alphanumeric string of characters encoded using the ASCII (American Standard Code for Information Interchange) encoding system.

8. The method of claim 6, wherein the positional data indicates each respective location which the search engine has encountered where the unique word that is the subject of that index entry occurs on the Internet.

9. The method of claim 7, wherein the string of alphanumeric ASCII characters represents the original double-byte binary value of an ideographic, logographic or pictographic character expressed in hexadecimal text format.

10. A method for indexing stored information comprising:
retrieving stored information comprising character information which is encoded using two bytes to represent each character;
converting the numerical values used to encode each character into hexadecimal text format to produce a hex value;
adding a predetermined marker character to the beginning of each hex value to produce a marked character value;
merging the marked character values into a single string of characters in the same sequential order in which they occurred in the stored information;
replacing each instance of the marker character with a blank space; and
adding each set of characters demarcated by a blank space to an index along with a pointer to the location at which that set of characters occurred.

11. The method of claim 10, wherein the stored information is stored as a plurality of pages on the Internet.

12. The method of claim 10, wherein the character information partially or wholly consists of encoded ideographic, logographic or pictographic characters such as Chinese characters.

13. A method for searching and retrieving stored information, comprising:
receiving a search query from a user comprising a number of ideographic, logographic, or pictographic characters encoded using two bytes to represent each character;
converting the numerical values used to encode each character in the search query into hexadecimal text format to produce a hex value;
adding a predetermined market character to the beginning of each hex value to produce a marked character value;
merging the marked character values into a single string of characters in the same sequential order in which they occurred in the search query;
replacing each instance of the marker character with a blank space; and
searching the index for each occurrence of the single string of characters.

14. A method for searching and retrieving stored information, comprising:
receiving a search query from a user comprising a number of ideographic, logographic, or pictographic characters encoded using two bytes to represent each character;
converting the numerical values used to encode each character in the search query into hexadecimal text format to produce a hex value;
adding a predetermined marker character to the beginning of each hex value to produce a marked character value;
merging the marked character values into a single string of characters in the same sequential order in which they occurred in the search query;
replacing each instance of the marker character with a blank space,
searching the index for each occurrence of each character contained in the search query;
examining the positional data describing the location of each occurrence of each individual character contained in the search query; and
determining whether the positional data indicates that any of the character occurrences contained in the index match the character comprising the search query.

15. The method of claim 14, wherein the stored information is a plurality of pages on the Internet.

16. A method for searching and retrieving stored information, comprising:
receiving a search query from a user comprising more than one ideographic, logographic, or pictographic characters encoded using at least two bytes per character;
converting the numerical values used to encode each character in the search query into hexadecimal text format to produce a hex value;
adding a predetermined marker character to the beginning of each hex value to produce a marked character value;
merging the marked character values into a single string of characters in the same sequential order in which they occurred in the search query;
replacing each instance of the marker character with a blank space; and
searching the index for each occurrence of the sequence of characters which comprise the sequence of characters contained in the search query.

17. The method of claim 16, further comprising:
searching the index for each occurrence of each individual character contained in the search query;
examining the positional data describing the location of each indexed occurrence of each individual character contained in the search query; and
determining whether the positional data indicates that any of the character occurrences contained in the index match the character string comprising the search query.

18. The method of claim 16, wherein the stored information is a plurality of pages on the Internet.

19. A computer-readable medium containing instructions for performing a method for indexing stored information that partially or wholly consists of encoded ideographic, logographic or pictographic characters, the method comprising:
creating an index entry for each individual character contained in the stored information using a search engine;
adding to the index entry for each individual character a pointer which indicates the location of each occurrence of that character which the search engine has encountered;
creating an index entry for each individual sequence of characters, up to a predetermined length, contained in the stored information using a search engine; and
adding to the index entry for each individual sequence of characters a pointer which indicates the location of each occurrence of that sequence which the search engine has encountered.

20. The computer-readable medium of claim 19, wherein the stored information is stored as a plurality of pages on the Internet.

21. The computer-readable medium of claim 19, wherein the characters are characters used to represent the Chinese language.

22. The computer-readable medium of claim 19, wherein the characters are encoded using two bytes per character.

23. The computer-readable medium of claim 19, wherein the stored information is stored in at least one storage device.

24. The computer-readable medium of claim 19, wherein the index entry comprises a unique word or phrase and positional data indicating the location of each occurrence of that word or phrase.

25. The computer-readable medium of claim 24, wherein the word or phrase comprises an alphanumeric string of characters encoded using the ASCII (American Standard Code for Information Interchange) encoding system.

26. The computer-readable medium of claim 24, wherein the positional data indicates each respective location which the search engine has encountered where the unique word or phrase that is the subject of that index entry occurs on the Internet.

27. The computer-readable medium of claim 25, wherein the string of alphanumeric ASCII characters represents the original double-byte binary value of an ideographic, logographic or pictographic character, or sequence of characters, expressed in hexadecimal text format.

28. A system for indexing stored information that partially or wholly consists of encoded ideographic, logographic or pictographic characters, comprising:
means for, including a search engine, creating a first index entry for each individual character contained in the stored information;
means for adding to the first index entry for each individual character a first pointer which indicates the location of each occurrence of that character which the search engine has encountered;
means for, including a search engine, creating a second index entry for each individual sequence of characters, up to a predetermined length, contained in the stored information using a search engine; and
means for adding to the second index entry for each individual sequence of characters a second pointer which indicates the location of each occurrence of that sequence which the search engine has encountered.

29. A system for indexing stored information, comprising:
a spider for retrieving a document containing a string of characters and for converting the numerical values used to encode each character contained in the document into hexadecimal text format to produce a hex value, and for adding a predetermined marker character to the beginning of each hex value to produce a marked character value, wherein the spider is also used for merging the marked character values in to a single string;
a storage device for storing the single string;
an indexer for replacing each instance of the marker character with a blank space and for adding each word separated by the blank space to an index database, and for adding positional data specifying the location of each word in the document.

30. A method for searching and retrieving stored information, comprising:
receiving a search query from a user comprising a number of ideographic, logographic, or pictographic characters encoded using at least two bytes to represent each character;
converting numerical values used to encode each character in the search query into an alphanumeric format to produce a numerical value;
adding a predetermined market character to the beginning of each numerical value to produce a marked character value;
merging the marked character values into a single string of characters in the same sequential order in which they occurred in the search query;
replacing each instance of the marker character with a blank space, and
searching the index for each occurrence of the single string of characters.
